(19) United States
(12) Patent Application Publication
(10) Pub. No.: US 2006/0182103 A1
(43) Pub. Date: Aug. 17, 2006

(54) System and method for routing network messages

(75) Inventors: Paul Martini, Escondido, CA (US); Peter Martini, Escondido, CA (US)

Correspondence Address: WILLIAM J. KOLEGRAFF, 3119 TURNBERRY WAY, JAMUL, CA, 91935, US

(73) Assignee: PHANTOM TECHNOLOGIES, LLC.

(21) Appl. No.: 11/059,042

(22) Filed: Feb. 16, 2005

(51) Int. Cl. H04L 12/28

(52) U.S. Cl. 370/389; 370/400

(57) ABSTRACT

A network routing system is provided that may establish a communication session between a local device and a remote destination. To establish a communication session, the local device generates a message directed to the remote destination. A traffic processor intercepts the message and redirects the message to a predefined network server in a secure fashion. The network server receives the message, and extracts the address for the remote destination, as well as message data. The network server has a pool of available virtual address that are registered with the network server. The network server associates a virtual source address with the real address of the local device or traffic processor, and opens a communication session. The virtual address is set as the source address for the message, and the message is sent to the remote destination. Since the source address is virtual, the real address for the local device or traffic processor are not sent to the remote location. If the remote location sends a return message, the return message will be directed to the virtual address. The network server receives the return message, and using the virtual address information, redirects the message to the real address for the traffic processor in a secure fashion. The traffic processor sets the address on the message to show it was sent from the remote destination, and forwards the message to the local device.

### CROSS REFERENCE TO RELATED APPLICATIONS

Not applicable.

### STATEMENT REGARDING FEDERALLY SPONSORED RESEARCH AND DEVELOPMENT

Not applicable.

### REFERENCE TO A COMPUTER LISTING, A TABLE, OR A COMPUTER PROGRAM LISTING COMPACT DISK APPENDIX

Not applicable.

### BACKGROUND

1. FIELD

The present invention relates generally to network computer systems. More particularly, the present invention relates to a system and process for routing network messages.

2. DESCRIPTION OF RELATED ART

The use of the Internet and other open networks has transformed personal and business communications. However, computers using these open networks are vulnerable to attacks by viruses, Trojans, spamware, spyware, and other undesirable processes. Often, users and network administrators load security software on individual computers to detect, and then remove, these undesirable processes. Unfortunately, the security software often disrupts local computer operations, interferes with locally attached devices, and removes or disables desirable messages and processes. Further, the security software must be continually updated and improved to address new security threats. This security software often needs the local user to make security decisions, or to decide what threats to authorize and which to reject. Too often, the local user makes the wrong choice, and security is breached. In some cases, the local security software becomes such a burden, or such a disruption of operation, that at local user will disable protections all together, leaving that user's device, and possibly the entire local network, vulnerable to attack.

Privacy is another concern in using an open network. In an open network, it is often possible to discover with whom a user is communicating, what network sites they are visiting, and possibly even the content of messages and emails. Such information may be embarrassing to the user if known. Or worse, the information may be used to hijack the user's identity for illegal purposes. Privacy issues are particularly critical for children using an open network. These children are not likely to fully understand the risks associated with privacy invasion, and may make security decisions that are exploited by predators.

### SUMMARY

Briefly, the present invention provides a network routing system for establishing a durable communication session that facilitates duplex communication between a local device and a remote destination. To establish a communication session, the local device generates a message directed to the remote destination. A traffic processor, which is coupled to the local device, determines if a session is active, and if not, initiates a new session. As part of the session initiation, a particular network server is associated with the traffic processor. The traffic processor intercepts the message from the local device and redirects the message to the network server. The message may be sent in a secure fashion using encryption. The network server receives the message, and extracts the address for the remote destination, as well as message data. The network server has a pool of available virtual address that are registered with the network server. When establishing the session, the network server associated a virtual source address with the real address of the local device or traffic processor. The virtual address is set as the source address for the message, and the message is sent to the remote destination after decryption if the destination is outside of the closed network. Since the source address is virtual, the real address for the local device or traffic processor are not sent to the remote location. Also, the originating device may no longer be associated with the data transaction if the data was sent in a secure manner to the Network Server before being decrypted and sent to the open network with virtual settings. Since multiple traffic processors may connect to the Network Server, each will have random virtual addresses known to the open network and no association of data headed to the open network may be permitted between the virtual addresses and the real addresses of the local devices. If the remote location sends a return message, the return message will be directed to the virtual address. The network server receives the return message, and using the virtual address information, redirects or maps the message to the real address for the traffic processor in an encrypted secure fashion. The traffic processor sets the address on the message to show it was sent from the remote destination, and forwards the message to the local device.

The network routing system may also enable a trustworthy and secure closed network. More particularly, secure and encrypted messages may be confidently routed among traffic processors and network servers. In this way, an open network, such as the Internet, may be used as the transport system for the secure closed network. Further, since all messages are processed through one or more traffic processors, security features may be implemented in the traffic processors, relieving the local devices of the risk and burden associated with installing and operating such processes. For example, the traffic processors may operate virus, spy ware, nanny ware, Trojan, or other security processes. These processes may be activated or updated using the network servers, and may cooperate with the network servers to provide additional security. Since all network processors receive communications from the Network Server, the additional processes may also be implemented centrally on the Network Server. For example, the network servers may be used to update encryption keys, or to implement new encryption algorithms. In another example, the traffic processor may have a port, such as a USB port or an RFID port, where a user may couple further security devices. The security device could be, for example, one or more private keys, a security card, or a smart card. The Network Server may also scan for viruses on all packets heading to or leaving the network processors. Thus all packets received by the Network Processors would be clean and free of malicious content.

These and other features of the present invention will become apparent from a reading of the following description, and may be realized by means of the instrumentalities and combinations particularly pointed out in the appended claims.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a block diagram of a message routing system in accordance with the present invention.

FIG. 2 is a block diagram of a message routing system in accordance with the present invention.

FIG. 3A is a block diagram of messages generated in accordance with the present invention.

FIG. 3B is a block diagram of messages generated in accordance with the present invention.

FIG. 4 is a block diagram of a message routing process in accordance with the present invention.

FIG. 5A is a block diagram of a message routing system in accordance with the present invention.

FIG. 5B is a flowchart of session establishment in accordance with the present invention.

FIG. 6 is a flowchart of processing an outgoing message in accordance with the present invention.

FIG. 7 is a flowchart of processing an outgoing message in accordance with the present invention.

FIG. 8 is a flowchart of processing a return incoming message in accordance with the present invention.

FIG. 9 is a block diagram of a closed network system in accordance with the present invention.

FIG. 10 is a block diagram of Ethernet messages generated in accordance with the present invention.

FIG. 11 is a lookup table associating real addresses with virtual addresses in accordance with the present invention.

### DETAILED DESCRIPTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure, or manner.

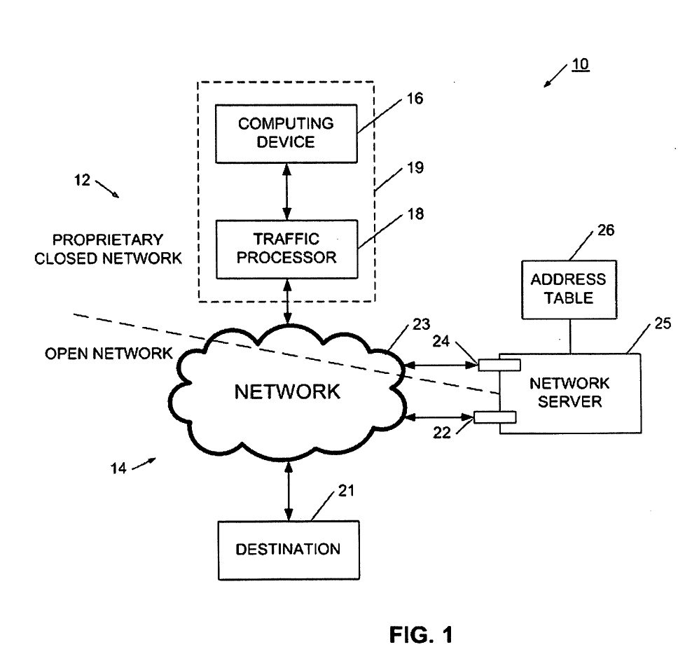

Referring now to FIG. 1, a system for routing network messages is illustrated. System 10 is useful for communicating within a proprietary closed network 12, or for providing enhanced communications with an open network 14. System 10 generally includes a local computing device 16 for originating and receiving messages. The computing device may be, for example, a personal desktop computer, a lap top computer, a personal data assistant, or a wireless mobile device, or a network router/gateway. The computing devices 16 couples to a traffic processor 18. In one example, the traffic processor 18 is a separate device from the computing device 16. In another arrangement, the traffic processor 18 and a computing device 16 are included in a single computing processor 19. The traffic processor 18 couples to a network 23. The traffic processor 18 may coupled directly to the network 23, or may couple through other devices, such as routers, switches, or hubs. In one example, the traffic processor 18 communicates with the network 23 through an Ethernet connection. The network 23, which may be the Internet, comprises many interconnected servers, which facilitate end to end communication through the network.

One network server 25 may be pre-defined to cooperate with the traffic processor 18. This level of cooperation may be useful for providing a highly secure proprietary closed network, which uses an open network for communication, or may be useful for providing enhanced communication over the open network. In one example of the system 10, the traffic processor 18 is configured to only communicate with the network server 25 through the network 23. In this way, every outgoing message generated by computing device 16 must be received by network server 25, and every network message directed to the computing device 16 must first pass through network server 25. When used as a proprietary closed network 12, system 10 routes all messages from known traffic processors, such as traffic processor 18, through known network servers such as network server 25. The network server 25 may use a network interface 24 for communication with the traffic processors on the closed network. In this way, all communication in the closed network is among known and predefined traffic processors and servers, thereby limiting available communication paths. Further, proprietary and additional security processes may be used in the closed network. For example, information packets may be encrypted using private security keys not known outside the closed network.

The network server also permits communications on the open network 14, for example, to destination 21. When communicating on the open network, the network server may use network interface 22. By using a separate network interface for the open and closed networks, additional security and firewall protection is enabled. When operating to facilitate communication to the open network 14, system 10 restricts access to the computing device 16 from devices on the open network. In this way, security vulnerabilities are reduced. For example, hackers will not be able to discover the real network address of the computing device 16, and viruses or Trojans may not be sent directly to the computing device 16. To facilitate this level of security, the network server 25 maintains an address table 26. The address table 26 includes a translation table that associates a real address related to the computing device 16 with a virtual address. In this way, an outside computing device such as destination 21, would not know the address of the computing device 16 or the traffic processor 18, but would communicate with a virtual IP address at the network server 25. In this regard, the network server 25 associates the virtual addressing with the real addressing, facilitating communication from the destination to the computing device 16, without disclosing its real address to the open network. Also, any message traveling between traffic processor 18 and network server 25 is encrypted and secured. By the time it is decrypted and put in unsecured form, the message is marked by virtual addresses retrieved from table 26. Using this technique, no association between computing device 16 and the data sent to the open network can be made. Destination 21 does not know the real address of local device 16 and can make no association of the data with local device 16. By both encrypting the messages, and by providing for virtual addressing, the privacy of the computing device 16 is protected.

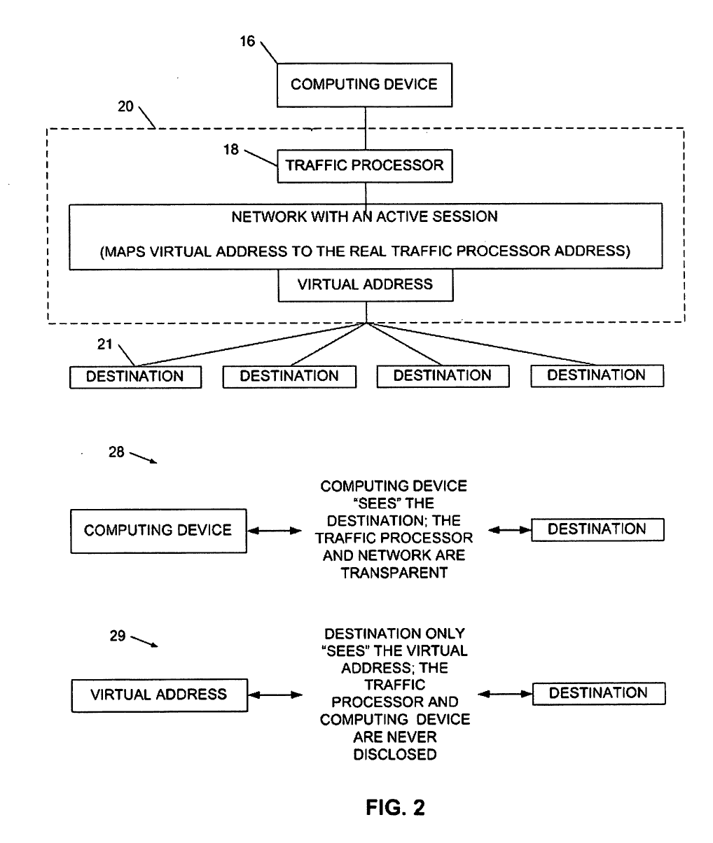

To facilitate transparent, convenient, and controlled communications, the communication system 10 establishes a durable communication session for a computing device, such as device 16. The session is typically established when the computing device first initiates a communication, and remains active for a period of time. Once the session is established, the computing device may communicate with destinations on the open network, and selected open network destinations may communicate with the computing device. As shown in FIG. 2, the communication device is physically coupled to a traffic processor 18. The traffic processor and network servers 20 cooperate to establish a session for the computing device, so the computing device 16 may communicate with a destination, such as destination 21. In part, establishing the session associates a virtual address with the traffic processor 18. Then, during communication, the session system 20 maps the virtual address to the real address of the traffic processor. However, the session and its mapping is transparent to the computing device 16, so from the computing device's perspective 28, the computing device is sending messages to the destination and receiving messages from the destination as if the session system 20 did not exist. In this way, the computing device is not required to make any accommodations or adjustments when communicating to a destination on the open network.

However, from the destination's perspective 29, the destination receives messages from the virtual address, and sends return messages to the virtual address. In this way, the destination is permitted to communicate with the computing device 16, but the destination never receives any indication of the real address of the traffic processor or the computing device. Further, as long as the session remains open, the destination is allowed to originate messages, which will be mapped to the computing device. Further, since all communication between the Network Server and the traffic processor are encrypted and secure, no association between computing device 16 and the response coming from destination 29 can be made. It will be appreciated that the session may remain open for a predetermined period of time, such as a set number of hours or days, or may be closed responsive to some other event. For example, the use of the computer may request that all sessions be closed to disable destination originated messages, or, responsive to a security attack, the network may reset the session.

A specific example of a session creation process follows:
1. The traffic processor creates a session connect packet addressed to the network server.
2. The packet contains 64 bits (half) of a predefined key, which is distributed (hidden) throughout the packet in bytes. The network processor applies a predefined challenge algorithm to arrange and position the key bytes in the packet.
3. The traffic processor uses its 256 bit master key to encrypt the packet containing half the key in the challenge.
4. Packet is sent to network server from the traffic processor.
5. Network server receives the packet, determines based on the ID of the header that there is no session established. At this point, the network server requests the master key from the database server.
6. The database server indicates in its response to the network server whether this network server will handle this session. If this network server will handle the session, go to step 7c. Otherwise, go to 7a.
7a. Network server is told to forward the connection to another network server (maybe due to loading) and the network server forwards the connection request to the new network server which will handle the connection. Go to 7b.
7b. The new network server receives the packet which was forwarded and begins processing. Go to step 7c.
7c. The master key is returned from the database server and it is used to decipher the packet. Once the packet is deciphered and verified for integrity (no data content has been removed or modified), the network server identifies this is a connect packet from the traffic processor.
8. The network server applies its predefined challenge algorithm to determine the position of and extract the session key from within the packet that was sent by the traffic processor. The network server generates a challenge response which itself is a challenge for the network processor which contains the second half of the 128 bit key (8 bytes) hidden within the response packet. The network server now contains a full 128 bit key for session which is formed by combining the challenge from the network processor and the challenge response that it generated. This session key may them be stored in a table for use during the session.
9. The network server encrypts challenge response packet with the 256 bit key returned from the database server (which is the master key of the traffic processor) and sends it to the traffic processor.
10. The traffic processor receives the packet, deciphers it and verifies it integrity. The traffic processor realizes this is a response to the connect request. At this point, the traffic processor solves the network server's challenge response and determines where the second half of the key is stored which is scattered throughout the packet. The network processor now has the 128 bit key by combining the challenge response key with the challenge key sent out in the connect request.
11. A durable, but time limited, session is established for the traffic processor and its associated local computing device.

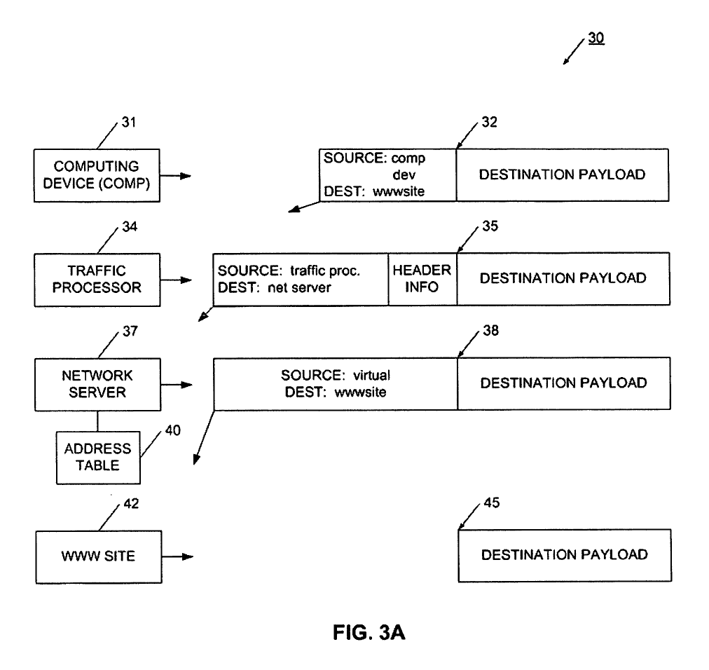

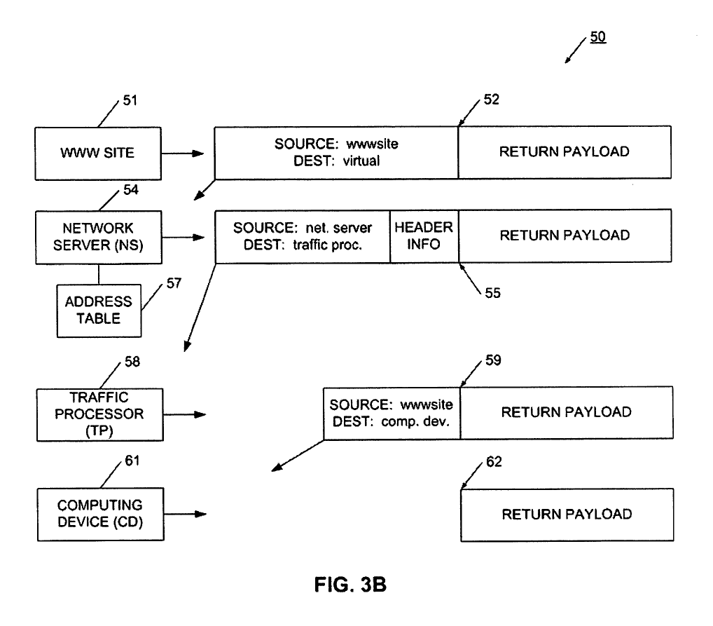

Referring now to FIG. 3A, a traffic routing process 30 is illustrated. Traffic routing process 30 may be advantageously used on a network system, such as network system 10 discussed with reference to FIG. 1. Process 30 has a computing device 31 which generates an outgoing message 32. The outgoing message 32 has a destination payload which includes message packets. An address is associated with the destination payload. Typically, the address will include a source address as well as a destination address. As illustrated in process 30, a computing device 31 is identified as the source of message 32, and the destination for the message 32 is the “wwwsite” 42. Although the destination for the message is identified as “wwwsite” 42, the message 32 is intercepted by traffic processor 34. In one example, the traffic processor 34 intercepts each and every outgoing message generated by computing device 31. In this way, additional security may be established for all outgoing communications.

The traffic processor 34 has an associated network server 37. In this regard, the traffic processor 34 has been provided with a predefined address for the network server 37. It will be appreciated that this predefined network address may be static, or may be updated through various network services. For example, the initially selected network sever may be overloaded, and may instruct the traffic processor to select another network server for session establishment. It will also be understood that the traffic processor may have a list of network servers to select from, and may use different network server responsive to current network conditions. After a session has been established for the computing device, the traffic processor 34 accepts the incoming message 32 from the computing device 31. The traffic processor generates a new message 35 which has the real source address of the traffic processor 34, and a destination address set to the network server 37. The IP address used by the traffic processor 34 may be the same as the IP address of the computing device 31. In this, the normal IP allocation process used on the local network continue to operate normally, and the traffic processor is transparent to both the local network and to the computing device. It will appreciated that Internet devices also typically have a MAC layer identifier, or MAC address. This MAC address is used by, for example, routers, hubs, and switches for identifying hardware assets on the local network and transmitting Ethernet packets. To further assure the transparency of the traffic processor, the traffic processor may use the MAC address of the computing device. More specifically, the traffic processor determines the MAC address of the computing device, and then “clones” the MAC address and uses it for further communications. The traffic processor 34 may also create a new MAC address for computing device 31 thus removing association of Ethernet traffic on the local network to the computing device 31 that is generating them. The contents of the Ethernet destination payload remain unchanged, and some or all of the header information from message 32 may also be included. For example, the header info would include the final destination wwwsite. The traffic processor 34 secures the message by applying encryption before sending the message to Network Server 37. In this regard, there is no association or information that can be gathered when sending information to the network server 37 while using the real address of the computing device 31.

Since the traffic processor 34 is only able to effectuate communication with network server 37, message 35 is received at network server 37. The network server 37 generates a new message 38. In this regard, the network server 37 extracts the destination payload and the final destination address from message 35. The destination payload and the destination address are then used to build message 38. Message 38 is made unsecure by decrypting it to prepare message 38 for the open network. The source address for message 38 is obtained from an address table 40. The address table 40 is used to associate the real address of the computing device or the traffic processor with a virtual address. This virtual address is registered in the network to be associated with the network server 37. The message as sent from the network server 37 shows a virtual address as its source and “wwwsite” as the destination. Also, now that the contents of message 38 are made apparent as it is unsecure, it can only be associated with the virtual address thus removing association with computing device 31. Message 38 is then received at “wwwsite” 42. “Wwwsite” 42 extracts the destination payload 45 using standard and known processes. However, “wwwsite” 42 recognizes the source of the destination payload to be the virtual address as applied by the network server 37. Importantly, “wwwsite” 42 does not know the real address of the traffic processor 34 or computing device 31. Also, no association can be made with the data received at “wwwsite” 42 and computing device 31 as the data was secured while traveling with the real address of computing device 31.

Referring now to FIG. 3B, traffic routing process 50 is described. Traffic routing process 50 is useful for routing a return message responsive to the message sent in process 30 described earlier. In traffic routing process 50, “wwwsite” 51 generates a return message 52. Since “wwwsite” 51 saw the source of message 38 to be the virtual address, “wwwsite” 51 now sets the source address to be “wwwsite”, and the destination to be the virtual address. The virtual address has been registered and associated with network server 54 on the network. Accordingly, message 52 is received at network server 54. Upon receiving message 52, the network server 54 extracts the virtual address, and using address table 57, associates the virtual address with a real address of the traffic processor 58 or the computing device 61. As earlier discussed, the IP address of the traffic processor and the traffic processor are likely to be the same, and the traffic processor may also have the same MAC address as the computing device through a MAC address cloning process. The network server 54 also extracts the return payload and the source address from message 52, and encapsulates these into message 55. Network server 54 then secures the message 52 by encrypting using encryption. Message 55 is then sent to traffic processor 58. Traffic processor 58 receives the message 55, decrypts it, and extracts the source address information as well as the return payload data. The traffic processor generates a new message 59, which has a source address of “wwwsite”, and a destination of the computing device 61. The traffic processor 58 can only send message 59 to computing device 61. Computing device 61 receives message 59 and extracts the return payload. Importantly, computing device 61 sees the message 59 as having a source of “wwwsite” and a destination of the computing device 61. From the standpoint of the computing device 61, the message 59 followed a normal and expected network communication path. In this way, computing device 61 was shielded from the complexities involved in the traffic processor and network server processes. Also, as the message 55 traversed back to traffic processor 58, it was in secure form removing any relation between “wwwsite” 51 and computing device 61.

Further, since all messages are processed through one or more traffic processors, security features may be implemented in the traffic processors, relieving the local devices of the risk and burden associated with installing and operating such processes. For example, the traffic processors may operate virus, spy ware, nanny ware, Trojan, or other security processes. These processes may be activated or updated using the network servers, and may cooperate with the network servers to provide additional security. For example, the network servers may be used to update encryption keys, or to implement new encryption algorithms. It will also be appreciated that these additional security services may be implemented on the network server. Since the network server processes every message from the open network to the computing device, the network server apply virus, spy ware, nanny ware, Trojan, firewall, or other security processes. By implementing these process on the network server, security processes may be efficiently applied and updated.

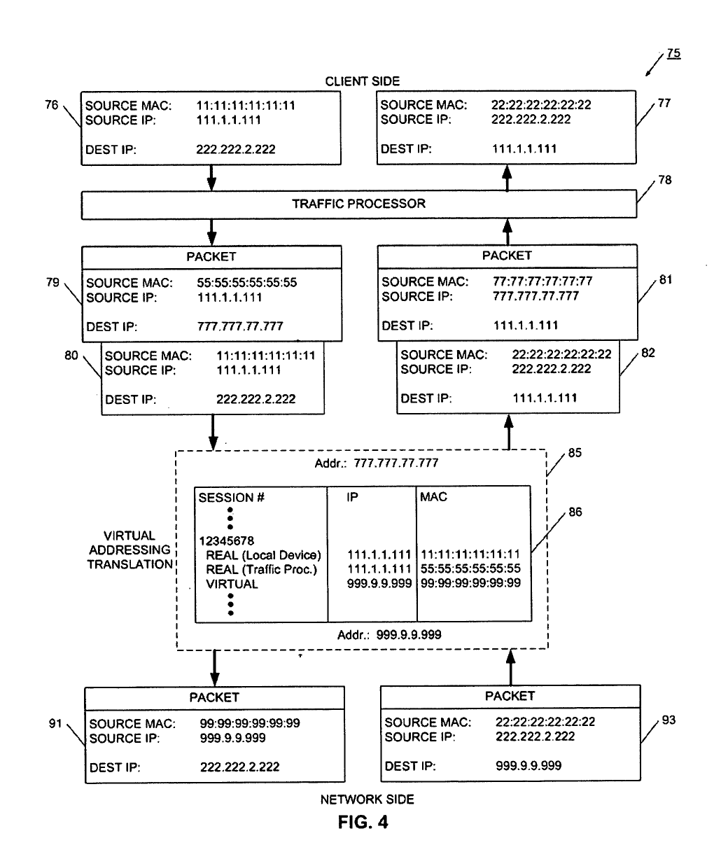

Referring now to FIG. 4, a message translation process 75 is illustrated. Message translation process 75 receives a message 76 from a local computing device. The local computing device may be, for example, a personal computer system, a portable computer, a personal data assistant, a gateway/router, or a mobile text device. Message 76 is received into a traffic processor 78. Traffic processor 78 may be a separate physical device coupled to the local device. The traffic processor may be coupled via a hardwire connection, or may be arranged wirelessly. In another example, the traffic processor 78 is integrally constructed with the local computing device. In another example, the traffic processor 78 may be a separate a software application operating on the local device. The traffic processor 78 receives message 76 and generates a new message 79. During a session establishment process, the traffic processor 78 is associated with a specific network server, and may be the only network device the traffic processor is permitted to communicates with. Accordingly, the traffic processor 78 has a defined address for a network server.

The traffic processor sets the destination of the new packet 79 to be the network server. The source address is a set to the source address of the traffic processor 78. In this way, the network server may easily and conveniently confirm that packet 79 was originated by traffic processor 78. In a more specific example, authentication is performed using encryption modes. AES mode may be used for encryption (ciphering) and CCM mode may be used for authentication. AES with CCM mode in combination can be used to confirm the integrity and originator of the message. It will be appreciated that other processes may be used to provide for message authentication and integrity. Some or all of the header information from message 76 is encapsulated 80 into message 79. For example, the final destination IP address is now encapsulated into the message. Optionally, the source address of the local device may also be encapsulated and transmitted to the network server. Typically, however, the complete original message is encapsulated into the new IP payload, which keeps the original message intact, including port settings, assignments, and header options. Using this process, the final destination will receive the entire packet as it was sent from the local computing device. Packet 79 is then sent to a network server in a secure encrypted fashion where a virtual addressing translation process 85 is performed. In one example, communications from the traffic processor are received on one network router access device for the network server, and the network server uses a different network access device to communicate with destinations on the open network. In this way, the computing device benefits from additional security features, such as firewall protection. In performing translation 85, the process uses a table 86 which associates real addresses with virtual addresses. More specifically, the real address of the traffic processor or the local device is associated with a virtual source address. In one example, the virtual address is a set of IP addresses and MAC addresses associated with the network server.

Further, the translation process may need to track port information for each session. Often, IP-based communication messages open particular communication ports between the computing device and a destination. For example, port assignments may be used by traditional routers or network address translation (NATs) process for correctly routing messages through firewalls or other security devices. By tracking opened ports, the network server is able to differentiate between a set of traffic processors all behind a single router and firewall. It will also be appreciated that this port information may be encapsulated in the messages forwarded to the traffic processors and computing devices.

Also, when process 85 assigns a virtual address, it may assign a unique session number. The session may remain open for a predefined period of time. By leaving the session open, return communications may be facilitated. For example, a session may be left open for a matter of minutes, a matter of hours, or maybe open for several days. In other applications, the session may remain open until expressly terminated by the administrator of the network server or by a user operating a utility application. In one example, a user may access a utility on the network server or traffic processor for identifying open sessions, and may select those sessions to close. It will be understood that while a communication session is open, the same virtual address may be used for both outgoing and return messages.

Process 85 generates a new message 91 which uses the virtual address as a source address, and the final destination as the destination address. Process 85 extracted the final destination address from the encapsulated 80 portion of message 79. Process 85 decrypts the message. Message 91 is then received at the destination address. From the viewpoint of the destination, message 91 was sourced from the virtual IP address. In this way, if the destination IP originates a return message 93, the return message 93 has a destination address set to the virtual address. Since the virtual address has been associated with a network server, message 93 is received at the network server and processed using the virtual addressing translation process 85. Translation process 85 uses table 86 to locate an open session using the virtual address. If an open session is found, a process 85 may associate the virtual address with the real address for the traffic processor or local device. Using this information, the process 85 generates a new message 81. The new message 81 uses the real address for the traffic processor as its destination, and sets the source address to be the network server. Also, the new message 81 is in secure encrypted form. The originating source address is encapsulated 82 within the message 81. Since message 81 is directed to the address of traffic processor 78, message 81 is received by the traffic processor 81. The traffic processor extracts the source address information from the encapsulated 82 portion of message 81 and sets it as the source address for new message 77. Message 77 is formed in insecure form by decrypting message 81. The traffic processor 78 also sets the destination address to the local device and forwards the message to the local device. As previously discussed, the IP address of the traffic processor is typically the same as the IP address of the computing device. Further, the traffic processor may be using a MAC address cloned from the computing device to further enhance transparency. In this way, the transmitting of message 76 and receiving of message 77 are accomplished, from a local device perspective, in the usual message transaction process. The local device has no visibility to the methods and structures provided by the traffic processor and network server. Further, the remote destination is enabled to receive and return communications to the local device, but yet does not have access to the real address of the local device. Also, the association of the data transaction between the remote destination and the local device have been decoupled and no association of the transaction between the remote destination and local device can be made due to the secure transaction while using the real address of the local device.

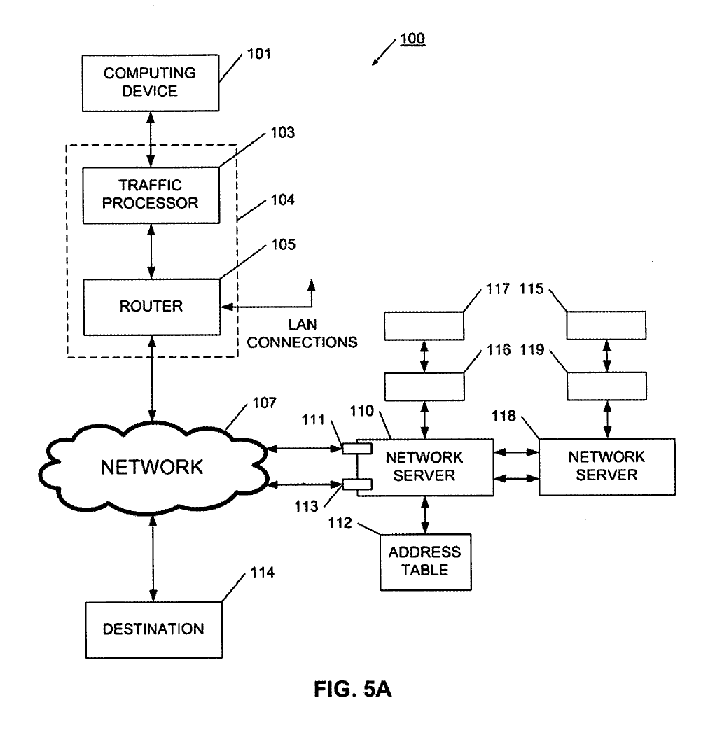

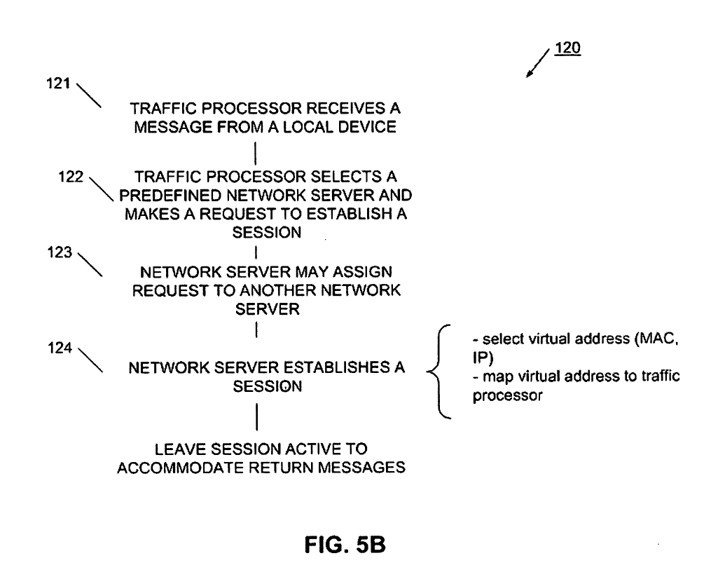

Referring now to FIG. 5A, a system 100 for routing network messages is illustrated. Network system 100 is similar to network system 10 discussed with reference to FIG. 1, so will not be discussed in detail. System 100 includes a computing device 101, which generates and receives messages. The computing device 101 is only allowed to send and receive messages through traffic processor 103. Traffic processor 103 may be associated with a router 105. In one example, the traffic processor 103 and the router 105 are incorporated into a single routing device 104. In other arrangements, the router 105 may coupled via wired or wireless connections to the traffic processor 103. The router 105 enables additional local area connections, such as through an Ethernet or wireless connection. The router may couple to a network 107, such as the Internet. The network 107 may have many interconnected servers, such as network server 110. One or more of the network servers have a predefined association with traffic processor 103. During the establishment of a session, the traffic processor 103 is restricted to communicate with only one of the network servers, such as network server 110. In this way, the traffic processor 103 sends and receives all its messages through server 110. As described earlier, the network server 110 has an address table 112 for providing an association between real addresses of the traffic processor or computing device with a set of virtual addresses. During the establishment of a session, the table is used to associate a virtual address with the real address of the traffic processor or computing device. Then, during the communication process, the table is used to map messages to and from the traffic processor and local device. In one example, the virtual addresses used in address table 112 are selected from a pool of available virtual addresses. These virtual addresses have been registered with the network server, thereby facilitating communication to and from a destination 114.

When computing device 101 sends a message, it is first received at traffic processor 103. The traffic processor 103 may determine if the computing device is attempting to communicate to a device on the local area network, or needs to communicate using network 107. If the traffic processor 103 determines that the computing device is communicating only on local area network devices, then the traffic processor may enable the router to forward the message directly to another local area device. Since the message does not transmit on the open network 107, security concerns are reduced. If however the traffic processor 103 determines that the computing device needs to route its message through the network 107, then the traffic processor will determine if a session is open, and if not, initiate the process of establishing a session. Once a session is established or open with server 110, the traffic processor takes the message it received from the computing device and generates a new message that is forwarded to the network server 110 in a secure encrypted fashion. In generating the new message, the traffic processor may encapsulate data and other information from the message originally generated by the computing device 101. The traffic processor will also encrypt or otherwise secure the message sent to the network server 110. Since the traffic processor 103 and the network server 110 have a predefined relationship, the encryption keys and encryption technology may be made very secure. When the message is received at the network server 110, it will confirm that the message has been sent from traffic processor 103. For example, header information included in the message may uniquely identify the traffic processor, and security codes may be used to facilitate validation. Once the network server 110 has validated the message from traffic processor 103, the network server 110 may determine if the end destination for the message is on the network's closed system, or whether the message's final destination is on the open network, such as destination 114. For additional security, the network server may have a router 111 or access device dedicated to the closed network, that is, for communications with traffic processors, and another access device 113 for communicating on the open network. The access device dedicated for communicating with the open network can be placed behind a firewall or have additional features such as antivirus protection. Using this arrangement, each traffic processors and its associated computing device receives the benefit of operating behind a router and its firewall protections.

If the network server 110 determines that the message is destined for a device on the closed network, then the network server may use a table of associated traffic processors to locate the traffic processor associated with the destination computer device. In one example, the network server finds that traffic processor 116 is associated with the final destination device 117. Traffic processor 116 has been associated with network server 110. In another example, the network server may find that traffic processor 119 is associated with the end destination computing device 115. However, traffic processor 119 is associated with network server 118. In this way, the network server 110 would forward the message to network server 118 which would then forward the message to traffic processor 119 and finally to local device 115. For communications within the closed network, communications may be encrypted to a private standard, and may have enhanced validation and security processes. On the other hand, if the message from computing device 101 is destined to a final destination 114 on the open network, then the message sent to destination 114 is likely to be sent unencrypted, or at least in a form expected by destination 114. As described with reference to FIG. 1, if the network server desires to forward a message from computing device 101 to destination 114, then the network server selects a source address from a pool of available virtual addresses. The network server sends the message to destination 14 showing the virtual address as the source of the message. In this way, if the destination 114 generates a return message, then the return message is sent to the network server 110, and the destination 114 has no visibility to the real address of computing device 101 or the traffic processor 103.

FIG. 5B illustrates the establishment of a session. A session is a temporary and durable arrangement that enables flexible and convenient communication, but in a secure and limited manner. A session allows a local computing device to have a presence on the open Internet, for example, while concealing its real address. This presence allows the local computing device to send messages to destinations, and, at a later time, allows the destination to originate a message to the local computing device. Indeed, as long as the session remains open, any destination that knows the correct virtual address may originate messages to the computing device. In an extreme example, the session may be made permanent. In this way, every destination that is aware of the computing device's virtual address may originate messages. In another extreme example, the session may be held open only for a brief period of time, thereby disallowing the destination from originating messages to the local computing device. Typically, however, the session will be established and remain open for a predetermined period of time, for example, a set number of days or hours or until the local device's network connection goes down (due to turning off the local device or some other reason). Also, it will be appreciated that more than one session may be open at one time, and that the time periods of sessions may overlap. In this way, if a first session is going to naturally expire in a short time, a new communication may be established on a second session that has more time remaining. It will be understood that the network or traffic processor may use other criteria for establishing new or additional sessions.

As shown in FIG. 5B, a traffic processor receives a message from its associated local computing device as shown in block 121. Provided that no session exists, or that the traffic processor determines that a new session should be established, then the traffic processor initiates the process of establishing a new session. The traffic processor selects a predefined network process, and makes a request to establish a session with that network server, as shown in block 122. In smaller installations, the traffic processor may have only one associated network server, so the establishment process may be abbreviated. In other cases, the traffic processor may have more than one server to choose from, and may make a selection based on current network conditions. After the traffic processor has made an initial request to establish a session with a network server, the network server may determine that another network server is better able to accommodate the request. For example, another network server may have more available bandwidth, or may have characteristics more suited to the type of communication requested. In this case, the initial network server would assign the session request to another network server, as shown in block 123. If another network sever is used, then the new server address is forwarded to the traffic processor, and the traffic processor continues the session establishment process with the new server. As part of this process, the network server has an available pool of virtual IP address and virtual MAC addresses that have been associated or registered with the network server. As shown in block 124, the network server associates a virtual address with the real address of the traffic processor. Once the network server has established a virtual presence for the local device, the session has been established and communications are enabled to and from the local computing device. As long as the session remains active, that is, the network server is allowed to use the virtual address to map messages with the correct traffic processor, full duplex communication is enabled. When the session is terminated, the virtual IP address may be returned to the IP address pool. Since the association between the real destination and the virtual IP address is now gone, and all real address information was fully encrypted, the privacy of the computing device is ensured.

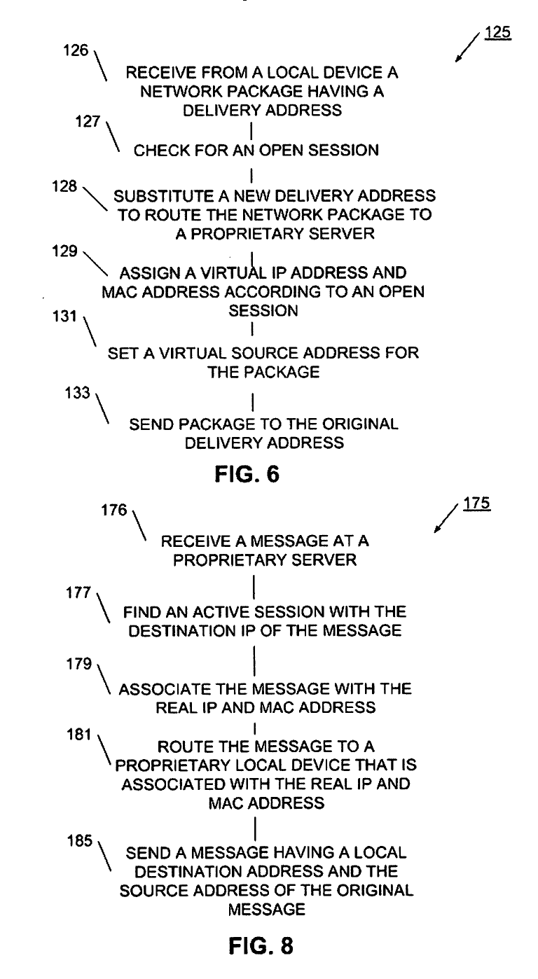

Referring now to FIG. 6, a process for routing network messages 125 is illustrated. Process 125 has a traffic processor receiving a network package from a local device as shown in block 126. The network package has both a data component and a delivery address. The traffic processor determines if an appropriate session is open and available as shown in block 127. If a session is available, then the traffic processor already has an associated proprietary server; if however, no session is available, then the traffic processor initiate a new session, and is thereby associated with a particular network server. The traffic processor substitutes a new delivery address, secures the packet and routes the data to the predefined proprietary server as shown in block 128. Further, the final delivery address has been encapsulated in the message. When the message is received at the proprietary server, the proprietary server decrypts the message and assigns a virtual IP address and a virtual Mac address according to the open session as shown in block 129. These virtual addresses then become the source for the message. It will be appreciated that the source address may include only an IP address, or may include both the IP and the Mac address, depending upon the specific network application. The virtual source address is then attached to the message package as shown in block 131, and the proprietary server transmits the message to the final delivery address as shown in block 133. In this way, the final destination receives the desired data packages, but sees the source to be the virtual address as assigned by the proprietary server. Also, the association between the data and the originator of the message have been decoupled.

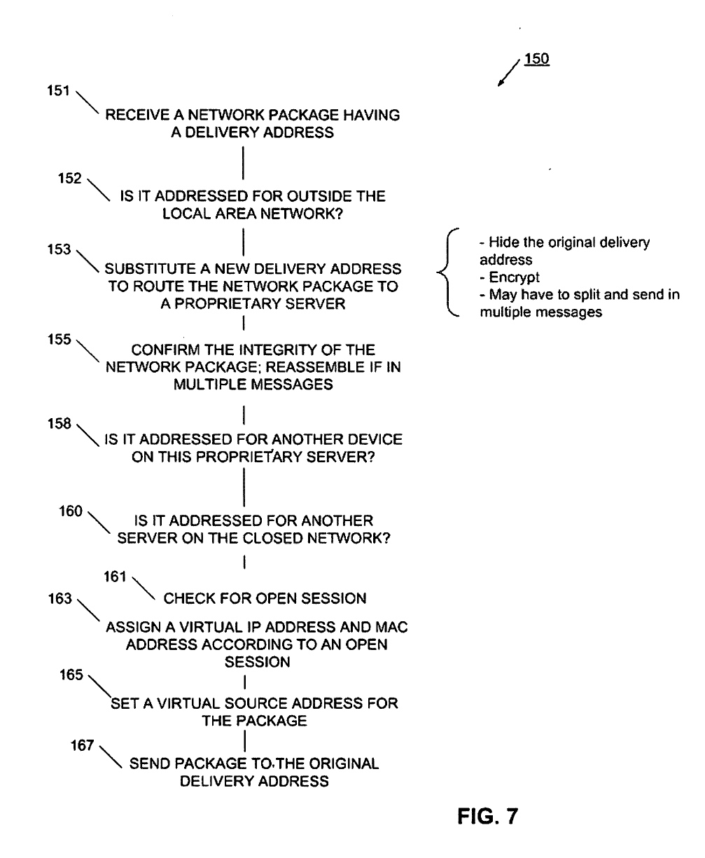

Referring now to FIG. 7, a method for routing network messages 150 is illustrated. Method 150 shows that a network package is received having a final delivery address as shown in block 151. The final delivery address is checked to see if it is addressed for outside the local area network. If the message is to a device within the local area network, the message may be forwarded to that device without using open network services and security. If the message must go outside the local area network, then the message is sent to a selected or predefined proprietary server, as shown in block 153. In one example, the message sent to the proprietary server encapsulates the original delivery addresses, and is encrypted for additional security and to obscure the content of the data being sent. Further, the message may include validation keys that will assist the proprietary server in verifying the validity and trustworthiness of the message. It will also be appreciated that in the process of sending the message to the proprietary server, the message may have to be split into 2 or more messages. In such a case, the message also includes header information as to the total number of message portions that will be transmitted to the proprietary server. In this way, when the network server receives a message, it may confirm that the entire message is contained in one transmission, or if it is merely a message portion which must be combined with other portions to reconstruct the complete message. As shown in block 155, the proprietary server confirms the integrity of the network package, and reassembles the message portion if the message was sent in multiple messages.

The network server may then check if the final destination is within the proprietary closed network as shown in blocks 158 and 160. In block 158, the proprietary server may determine if the final address is to a device associated with that network server. If so, the message may be forwarded in its encapsulated and encrypted form to the device. As shown in block 160, the network server may determine that the message has a final destination for a device associated with another proprietary server on the closed network. In this way, the network server would forward the message to the other network server, where the message would then be transmitted to the local device. In this transfer, also, the message transfer may be done in an encapsulated and encrypted manner. Described this far, process 150 provides a highly secure and trustworthy closed network for private communications using an open network transport system. For example, by using a set of traffic processors and one or more network servers, the open Internet may be used to facilitate a highly secure and trustworthy communication system. If the message is intended for delivery in to the open network, then the network server assigns a virtual source address to the message as shown in block 163. The virtual address is assigned according to an open session; if no session is open, then a session establishment process is used to open a new session and generate an association between a virtual address and the specific traffic processor. The network server may also have a unique session number for each session, so that return message and future outbound messages may be more easily handled and routed. During the establishment of a session, the virtual addresses are selected from a pool of available addresses. For example, the network server may have a set of IP addresses and MAC addresses at its disposal. Then, as source addresses need to be virtually assigned, addresses are removed from the pool and associated with the real address of a traffic processor or a local device. The virtual address is then set as the source address for the message as shown in block 165, and the message is forwarded to the original address as shown in block 167 in insecure form. In this way, the device at the destination receives the intended data, but sees the virtual address as the source. Accordingly, if the destination device desires to send a return message, but it will send a return message to the virtual source address, as the destination address has no visibility to the real address of the local device or traffic processor. Also, since the data is sent in encrypted secure form to the local device, the destination device does not know who will eventually receive the response as there may be many open sessions with secure tunnels to the Network Server.

Process 175 is particular to handling and routing a return message generated responsive to a message sent by process 125 or process 150. In process 175, a message is received at the proprietary server as shown in block 176. The proprietary server reviews its table of active sessions to find an active session associated with the received message as shown in block 177. More particularly, the network server maintains a table of virtual addresses which are associated with the real address of a local device or a traffic processor on its closed network. If the received message is from one of the virtual addresses, then the network server, using the lookup table, can associate the received message with a particular local device or traffic processor. The network server may apply rules or other security devices to determine if the message should be forwarded. For example, the network processor may scan the message for viruses, Trojans, or other unwanted software effects, or may restrict the size or timing of the message. In this way, the network server may apply virus, spy ware, and other security processes to the message prior to the message being allowed on the closed network.

Provided an active session has been found with regard to the virtual address, the virtual address can then be associated with the real address of a local device or traffic processor as shown in block 179. The network server may then route the message to the traffic processor in secure encrypted form as shown in block 181. The source address from the original message has been encapsulated in the message. The traffic processor receives the message from the network server, and may apply additional security processes. For example, the traffic processor may apply additional virus, spy ware, or other security processes to the message. Further, the local device may have configured the traffic processor to provide additional restrictions on receiving messages from that particular source. These additional restrictions may also be programmed from the closed network. In this way, the network server and network resources may set new, amended, or additional security processes at specific traffic processors. For example, virus software or a list of excluded source sites may be programmed remotely or locally into the traffic processors. The traffic processor then generates a new message that is sent to the local device as shown in block 185. The message sent to the local device will have the local device set as the destination address, and will have the remote device set as its source address. In this way, the local device is unaware of the processes performed by the traffic processor or the network server.

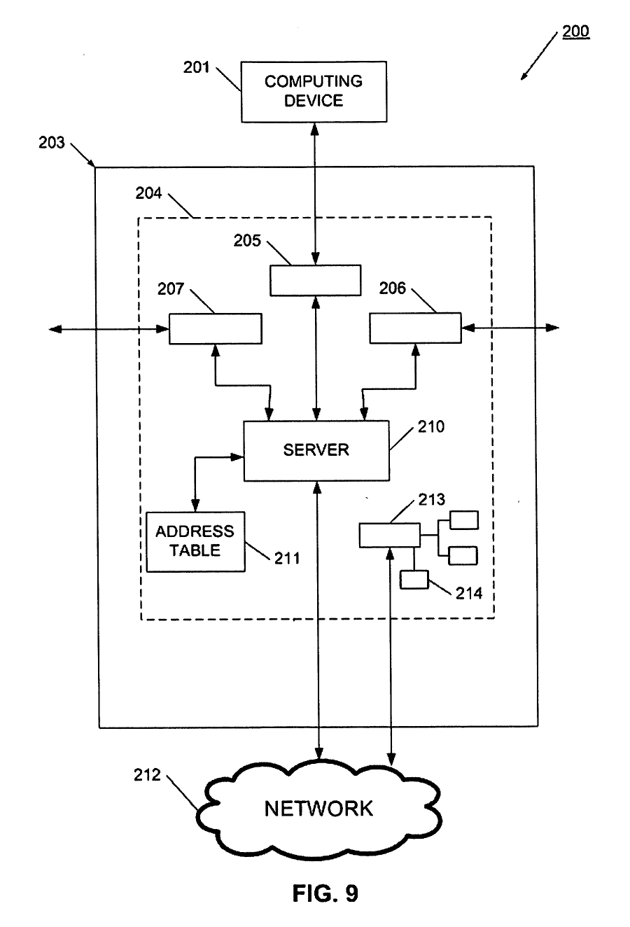

Referring now to FIG. 9, a network communication system 200 is illustrated. In one arrangement, system 200 may enable a highly secure and trustworthy closed network. Further, the closed network is easily extensible to enable communications with devices and users outside the closed network. System 200 has a computing device 201 that couples to the network 203. More particularly, computing device 201 couples to the more secure closed network 204. Provided computing device 201 only couples to the closed network 204, then the computing device 201 may be considered part of the closed network. More particularly, computing device 201 couples to a traffic processor 205. The traffic processor is enabled only to communicate with a selected proprietary server 210. Proprietary server 210 may have other associated traffic processors, such as traffic processors 206 and 207. Each of these traffic processors may have their associated computing devices. In this way, computing device 201 may communicate with devices coupled to traffic processors 206 and 207 without any access through the open network 212. The closed network 204 may also include other proprietary network servers 213. These servers, such as servers 213 may have their own set of associated traffic processors. By sharing server address information and traffic processor address information, information may be securely communicated within the closed network. For example, computing device 201 may generate a message, which is encrypted by traffic processor 205. Traffic processor 205 sends the secure message to network server 210, which then routes the secure and encrypted message to the appropriate traffic processor or proprietary network server. In this way, communication is facilitated in the closed network 204 in a secure and trustworthy manner. If communication is desired to devices outside the closed network 204, then the network servers have associated address tables 211 and 214 for providing virtual source addresses for open communications. In this way, communications outside the closed network do not reveal the real addresses of the traffic processors or the local computing devices and the data leaving the closed network can not be associated with any particular closed computing device such 201 since all communications within the closed network are secured

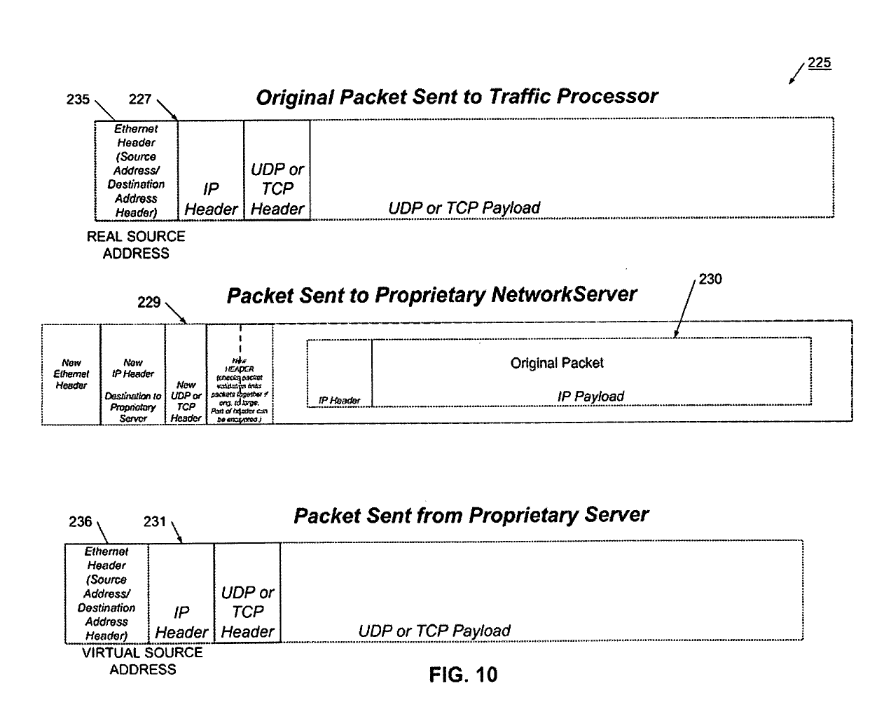

Referring now to FIG. 10, message packages 225 are illustrated. Message packages 225 represent more specific arrangements of message frames for an Ethernet based system. Message 227 represents an original message packet originated from a local computing device. The message 227 includes a message payload, as well as source and destination address information. A traffic processor generates a new message 229, which encapsulates some or all of the original message 227. Typically, however, the complete original message is encapsulated into the new IP payload of the new packet, which keeps the original message intact, including port settings, assignments, and header options. he encapsulated portion 230 may contain less than the entire original payload or the entire original packet, and may contain selected portions of the header or the entire header. Optionally, portions of the header may be removed for additional security purposes, or to minimize data transmissions. The packet 229 may also include additional information such as validation keys to assist in assessing the trustworthiness of the packet. As described earlier, the traffic processor may have to split the original message 227 into multiple messages to transmit to the network server. Accordingly, additional header information may be provided in message 229 to instruct the network server as to how many messages comprise the full original message. Message 229 is routed to the predefined proprietary server, where the proprietary server extracts the original destination address and the message payload. For example, the message payload may have to be reassembled from multiple messages.

The proprietary server also checks its list of active sessions to see if a communication session has already been established with the local computing device. If so, the proprietary server uses the established virtual address as the source address for message 231. If no session exists with the local computing device, then the proprietary server selects from a pool of available source addresses, a virtual source address to use as the source address 236 for message 231. The addresses in the pool of virtual addresses have been registered with the network and associated with the network server, so that messages sent to these addresses will be received by the network server. Because the network server may use a router device implementing Network Address Translation (NAT) to access the open network, requirements for registering individual IP addresses may be significantly reduced. In this regard, the port assignments for a single IP address may be set to accommodate the addressing of many individual devices. The process of using port assignments to route behind a router or firewall is well understood, and will not be addressed here in detail. Message 231 is then sent to the final destination, where the final destination receives the payload as sent by the local device, but the destination sees the source as being the virtual source as attached by the proprietary server. In this way, the final destination is shielded from discovering the real address of the traffic processor or the local device. Also, the destination or any other device on the open network can not associate the data transaction with the local device as the message was sent through the closed network to the Network Server which assigned virtual addresses to message 231 before being sent on the open network. Although the packages 225 have been discussed with reference to Ethernet, it will be appreciated that other network standards may be applied. For example, many network standards, use a frame based system having source and destination addresses. Each of these network standards could benefit from using a virtual addressing structure as described herein.

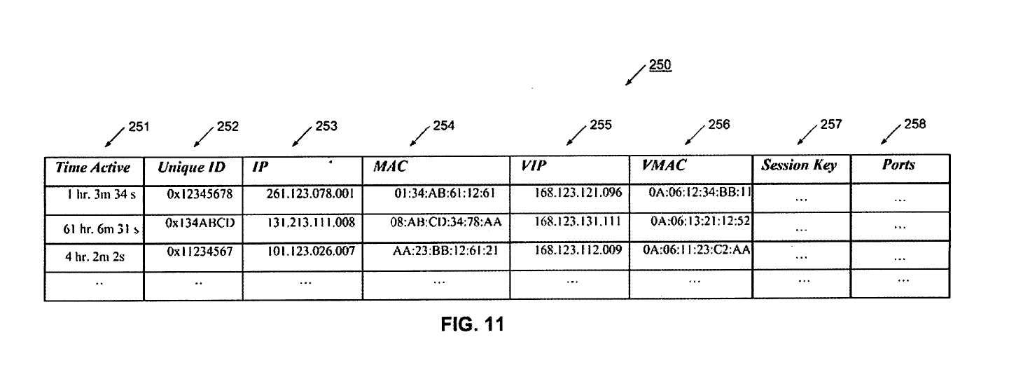

Referring now to FIG. 11, and translation table 250 is illustrated. Translation table 250 includes real address information 253 and 254 which is associated with a local device or a traffic processor. As illustrated, the traffic processor and the local computing device have the same IP address, and the traffic processor is using a MAC addressed cloned from the local computing device. Each real device has an associated virtual address 255 and 256. It is the virtual address 255 and 256 that is identified as the source for messages sent from the proprietary server. Accordingly, when a message is received from the virtual address, it may be reassociated with real address 253, 254. Further, the network server may track the open sessions by a unique ID 252. The sessions may be opened for a predefined period of time, or may be closed dependent on application-specific needs. The table may track the time active 251 for each session. Further, the table may include port assignments 258, as well as the session key 257 that was uniquely generated for each session. It will be understood that the information in table 250 may be collected and tracked using other processes, files, or database techniques. It will also be understood that the data may be distributed among devices, or centralized in one device.

While particular preferred and alternative embodiments of the present intention have been disclosed, it will be apparent to one of ordinary skill in the art that many various modifications and extensions of the above described technology may be implemented using the teaching of this invention described herein. All such modifications and extensions are intended to be included within the true spirit and scope of the invention as discussed in the appended claims.

What is claimed is:

1. A method for routing network messages, comprising:
receiving a message packet from a local device, the message packet having a final destination address;
establishing a communication session with a predefined network server;
routing the message packet to the predefined network server;
assigning a virtual address to the message, the virtual address being registered with the network server; and
transmitting the message to the final destination, the message using the virtual address as the source address.

2. The method of claim 1, further comprising:
receiving at the network server a return message originated from the final destination address;
determining a real address associated with the virtual address; and
routing, using the real address, the return message to the local device.

3. The method of claim 1, further comprising encrypting at least a part of the message packet prior to routing the message packet.

4. The method of claim 1, further comprising opening the communication session to facilitate communication between the local device and the final destination, the session being associated with the virtual address.

5. The method of claim 4, wherein the session is left open for more than 1 hour.

6. The method of claim 1, further comprising:
providing a pool of available virtual addresses;
selection the virtual address from the pool.

7. The method of claim 1, wherein the virtual address includes an Ethernet IP address.

8. The method of claim 1, wherein the virtual address includes an Ethernet MAC address.

9. The method of claim 1, wherein the routing address is a static address.

10. A closed network, comprising:
a traffic processor, operating the steps of:
receiving message packets from a local device, the message packets being addressed to a final destination address; and
routing the message packets to a server at a predefined address in a secure manner;
the server operating the steps of:
receiving the message packets routed from the traffic processor;
decrypting the message if headed to the open network associating a new source address with the message packets, the new source message being different than the address of the traffic processor and different than the address of the local device; and
transmitting the message packets to the destination address.

11. The closed network of claim 10, wherein the server operates the additional steps of:
receiving return message packets from the destination address, the return message packets having the “new source address” as the destination address;
associating the return message packets with the local device; and
routing the return message packets to the traffic processor in a secure manner.

12. The closed network of claim 11, wherein the traffic processor operates the additional steps of:
receiving the return message packets from the server and decrypting the message;
setting the “destination address” as the source address for the return message packets; and
routing the message packets to the local device.

13. The closed network of claim 12, wherein the traffic processor is constructed to only receive return message packets from the predefined server.

14. The closed network of claim 13, wherein the traffic processor is constructed to only route return message packets to the local device.

15. The closed network of claim 10, wherein the step of routing the message packets includes splitting the message packets into a plurality of messages.

16. The closed network of claim 10, wherein the server transmits the message packets to another traffic processor associated with the server.

17. The closed network of claim 10, wherein the server transmits the message packets to another traffic processor associated with another server.

18. The closed network of claim 10, wherein the traffic processor is constructed to only route local device message packets to the predefined server.

19. The closed network of claim 10, wherein the traffic processor is in the local device.

20. The closed network of claim 10, wherein the traffic processor further includes an Ethernet connector for coupling to an Ethernet line.

21. The closed network of claim 10, wherein the traffic processor is arranged as a set of instructions operated by a processor.

22. A traffic routing process, comprising:
receiving Ethernet message packets from a local device, the Ethernet message packets being addressed to a remote final destination address;
determining that a communication session is open with a network server, the communication session providing a predefined server address;
generating a new message, the new message encapsulating the Ethernet message packets; and
transmitting the new message to the server at the predefined address.

23. The traffic routing process of claim 22, further including the steps of:
securing the new message with encryption prior to transmitting the message; and
decrypting the message at the server.

24. The traffic routing process of claim 22, wherein the predefined address is the only address to which the new message is capable of being transmitted.

25. The traffic routing process of claim 22, further comprising the steps of:
receiving a return message from the server;
extracting return message packets from the return message;
extracting a source address from the return message, the extracted source message being indicative of the final destination address;
setting the extracted source address as the source address for the return message packets; and
transmitting the return message packets to the local device.

26. A message translation process, comprising:
receiving message packets from a real device;
extracting a destination address from the message packets;
extracting data packets from the message packets;
providing a pool of available virtual source addresses;
selecting one of the source addresses to associate with the message packets as a virtual source address;
assembling a new message, the new message comprising:
the extracted destination address;
the selected virtual source address; and
the extracted data packets; and
transmitting the message packets to the destination address.

27. The process of claim 26, further comprising the step of decrypting the received message.

28. The process of claim 26, further comprising:
receiving return message packets, the selected virtual source address now being indicated as the destination of the return message packets;
using the received “selected virtual source address” to determine the real address for the real device;
extracting data packets from the message packets;
assembling a new return message, the new return message comprising:
the real address as the destination; and
the extracted data packets; and
transmitting the new return message packets to the real device.

29. The process of claim 28, further comprising the step of securing the new return message with encryption prior to transmitting the new return message to the real device.
